(19) United States
(12) Patent Application Publication
(10) Pub. No.: US 2009/0001196 A1
(43) Pub. Date: Jan. 1, 2009

(54) Nozzle for Droplet Jet System Used in Oral Care Appliances

(75) Inventor: Joseph W. Grez, North Bend, WA (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/097,257

(22) PCT Filed: Dec. 13, 2006
(86) PCT No.: PCT/IB2006/054789

§ 371 Date: Jun. 12, 2008

Related U.S. Application Data
(60) Provisional application No. 60/749,800, filed on Dec. 13, 2005.

(51) Int. Cl. B05B 3/00

(52) U.S. Cl. 239/229

(57) ABSTRACT

The nozzle member (10) includes a flexible, resilient portion (14) at the front end thereof which has an opening (32) through which fluid droplets move to a target. in the event that a clogging element blocks a portion or more of the opening, the flexible, resilient portion distorts and expands outwardly under increased pressure resulting from the pressure of the clogging in the nozzle, resulting in a sufficient increase in size of the opening to let the clogging element pass out of the nozzle.

This invention relates generally to oral care appliances, as well as other appliances or devices, which use a stream of fluid droplets for cleaning/washing, and more specifically concerns nozzle arrangements for such fluid droplet systems.

All fluid droplet systems for cleaning or washing use a nozzle through which liquid droplets move at high speed to a target. Droplet systems with a nozzle or nozzles are present in various appliances and devices, including specifically oral care devices, but also showerheads, dishwashers and other spraying devices used for cleaning. The fluid opening for the nozzle needs to be quite small in order to produce small but fast-moving droplets using fluid and/or air pressure to accelerate the droplets.

The manufacture of nozzles with the proper small orifices is often difficult due to the machine tolerances required, compared to normal manufacture of such devices. The small orifice in the nozzle, furthermore, can easily clog and often in such a manner that cannot be readily corrected. The use of fluids in a normal (non-clean room) environment typically will result in particulates, such as dust, being present in the pumping system, creating clogging of the nozzle. In certain applications, a user will have no equipment or ability to accomplish an unclogging of the nozzle.

While use of filters upstream of the nozzle can reduce clogging, such filters often become clogged as well, thereby adding to the problem. Besides particulates in fluids being trapped in the nozzle during actual fluid flow, particulates can be left behind when fluids are allowed to dry out in an orifice, which results in clogging as well. Clogging can be either complete, which leads to a total loss of nozzle functionality, but also partial, which can result in a non-uniform spray or spray hotspots, which can cause damage to the target areas, particularly teeth and gums in an oral care application.

Accordingly, it is desirable that a nozzle be designed to be self-correcting, i.e. a nozzle which can in normal operation maintain itself clean and free of clogging.

Accordingly, the present invention is a nozzle structure for a fluid droplet generation system, comprising: a nozzle member having an orifice at a front end thereof for permitting fluid droplets to move outwardly therefrom to a target, wherein the orifice is defined in a flexible, resilient portion, such that if a clogging element blocks a portion or more of the orifice, fluid pressure builds up from the rear of the flexible portion, forcing the flexible portion to expand outwardly, increasing the size of the orifice, so as to let the clogging elements pass through the opening, the nozzle thus being self-cleaning in operation.

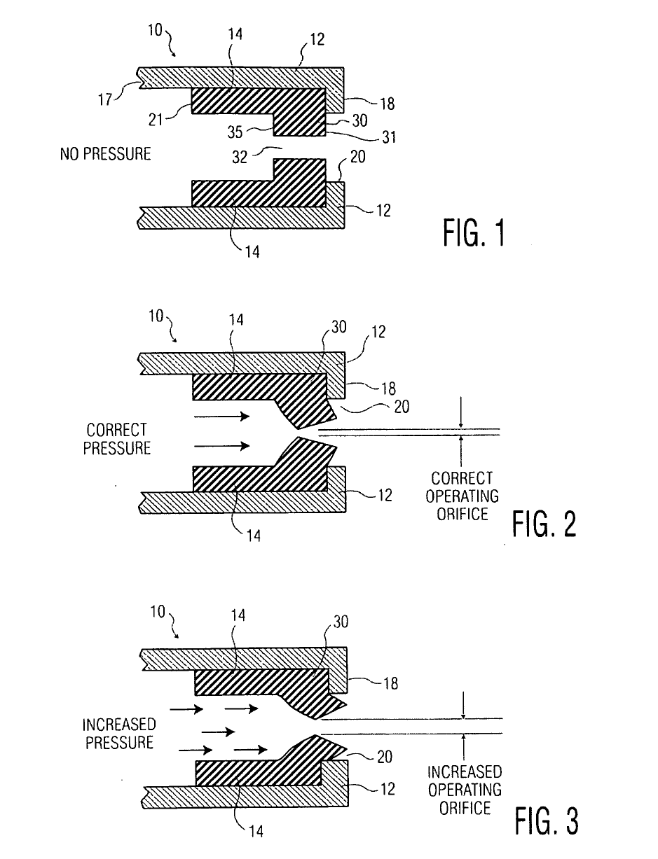

FIGS. 1, 2 and 3 are cross-sectional view of a self-cleaning nozzle structure illustrating a no fluid pressure condition in FIG. 1, a correct pressure condition in FIG. 2, and an increased pressure condition in FIG. 3 which allows a clogging element to pass through the orifice.

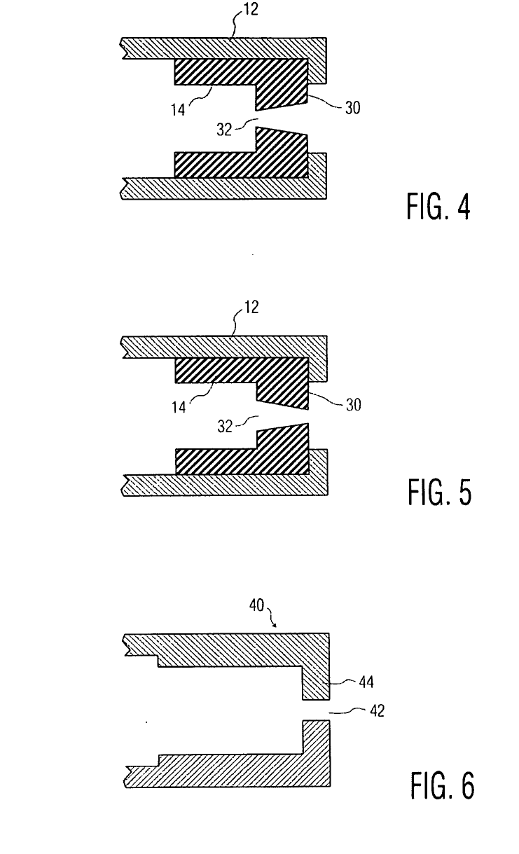

FIGS. 4 and 5 are cross-sectional views of modifications of the embodiment of FIG. 3.

FIG. 6 is a cross-sectional view of an alternative embodiment.

FIGS. 1, 2 and 3 show a fluid droplet nozzle 10. Nozzle 10 could be used in an oral care appliance, or it could be a part of another fluid droplet cleaning application, such as a showerhead or other item/appliance which uses a fluid droplet spray for cleaning or washing, including, for instance, a dishwasher or other similar appliance/system. However, for purposes of explanation herein, nozzle 10 is described in an oral care appliance application. In use of such an oral care appliance, nozzle 10 is typically positioned in the mouth. Fluid droplets, which could be water or various dentifrices or other similar fluids, are accelerated through the nozzle 10 onto the teeth or other portions of the oral cavity of the user, as desired. The acceleration of the droplets can be achieved by various means, including pressurized air as well as by other means known in the art.

In the embodiment shown, nozzle 10 includes an outer rigid housing portion 12 and an inner flexible, resilient orifice portion 14. Outer portion 12 is made from a rigid material such as a metal, e.g. stainless steel, and can have various configurations. In one configuration, housing portion 12 will be cylindrical, with a wall thickness of approximately 0.1 mm or less, from a rear end 17 to exit portion 18 at the front end, which includes an opening 20. The size of opening 20 can, of course, vary, depending upon the application. The length of the exit portion (back to front) can for example be approximately the same as the thickness of the cylindrical wall of the outer portion, as shown in FIG. 1.

Fitted within outer portion 12 is orifice portion 14, which abuts against the back surface of exit portion 18 of housing portion 12. In the embodiment shown, orifice portion 14 is also generally cylindrical, having a length of approximately 6 mm, although this can vary, and a wall thickness similar to that of portion 12, from a rear end 21 to a forward part 30, which has in the embodiment shown a central opening 32 of approximately 150 microns (diameter) and a length of approximately 0.1 mm from back to front thereof. These dimensions can also vary, depending upon the particular application.

Orifice portion 14 is made out of a flexible, resilient material, for example an elastomeric material which could be rubber or injection moldable thermoplastic, with the hardness of the material being selected to provide an operational advantage.

Nozzle 10 is self-cleaning, because of the flexibility of the orifice portion. For best results in self-cleaning, the diameter of central opening 32 in forward part 30 at forward surface 31 is the same (FIG. 1) or smaller (FIG. 5) than the diameter of the opening 32 at the rear surface 35 of forward part 30, when there is no fluid pressure. FIGS. 1, 2 and 3 show the self-cleaning operation of a nozzle with that configuration.

FIG. 1 shows nozzle 10 with no fluid pressure and hence no fluid exiting through opening 32 in the forward part 30 of orifice portion 14. In this condition, forward part 30 is undistorted; the opening is approximately 200 microns in diameter. In FIG. 2, fluid is moving through forward part 30 at a correct (normal operation) fluid pressure. Forward part 30, under normal pressure, distorts forwardly in the direction of fluid flow, resulting in a decrease in the diameter (to approximately 150 microns) of opening 32. This is the normal operating configuration for the nozzle. When the opening becomes clogged by a clogging element, the pressure to the rear of the forward part 30 will increase significantly. This pressure results in a further forward movement/distortion of the forward part 30, resulting in an increase in diameter of opening 32, as shown in FIG. 3. The opening is now large enough to permit clogging elements to pass through.

Following the release of the clogging elements, the pressure decreases back to a normal pressure value and the forward part 30 reverts to the configuration of FIG. 2.

If, on the other hand, opening 32 at the rear surface 35 has a smaller diameter than at the forward surface 31 (for a no-pressure condition) as shown in FIG. 4. the fluid flow through the nozzle will be the same over a selected range of pressure. In this arrangement, a varying pressure over a selected range will result in the same distortion of the forward part 30 and the diameter of opening 32 will not change, thereby maintaining a constant fluid flow over a range of pressure.

Hence, the configuration of opening 32, in a flexible, resilient orifice portion, can be used to produce a self-cleaning effect, i.e. eliminating clogging (FIGS. 1, 5), or it can be used so as to maintain a desired flow rate over a selected range of pressure (FIG. 4).

Although the embodiment shown in FIGS. 1-3 includes a rigid housing and a flexible orifice portion insert, the nozzle can be made entirely of a flexible material such as an elastomeric or rubber, as shown in FIG. 6. The nozzle is shown generally at 40 with an opening 42 in the forward end portion 44 of the nozzle. This arrangement will generally provide desirable results, although the embodiment of FIGS. 1-3 is typically more stable over long term operation.

Hence, a nozzle arrangement for a fluid droplet system has been described which in operation results in a desirable self-cleaning effect during operation, wherein when clogging occurs, pressure builds up in the rear of the nozzle, producing a sufficient distortion of an elastomeric insert portion to allow the clogging elements to pass through the nozzle.

Although a preferred embodiment of the invention has been disclosed here for the purposes of illustration, it should be understood that various changes, modifications and substitutions may be incorporated in the embodiment without departing from the spirit of the invention, which is defined by the claims which follow.

1. A nozzle structure for a fluid droplet generation system, comprising: a nozzle member having an orifice at a front end thereof for permitting fluid droplets to move outwardly therefrom to a target, wherein the orifice is defined in a flexible, resilient portion, such that if a clogging element blocks a portion or more of the orifice, fluid pressure builds up from the rear of the flexible portion, forcing the flexible portion to expand outwardly, increasing the size of the orifice, so as to let the clogging element pass through the opening, the nozzle thus being self-cleaning in operation.

2. The nozzle structure of claim 1, wherein the flexible portion is made from an elastomeric material.

3. The nozzle structure of claim 1, including an outer rigid portion into which the flexible portion fits, wherein the flexible portion includes a forward part having a central orifice opening therethrough, the forward part being configured and arranged such that it distorts forwardly under fluid pressure from the rear, wherein pressure increases above a normal operating pressure when a clogging element blocks a portion or all of the opening, in which case the increased pressure produces additional distortion of the forward portion sufficient to increase the size of the opening to permit the clogging elements to pass therethrough.

4. The nozzle structure of claim 1, wherein the diameter of the orifice at the front surface of the forward part is the same or smaller than the diameter of the orifice at the back surface under a no-pressure condition.

5. The nozzle structure of claim 1, wherein the diameter of the orifice at the front surface of the forward part is larger than the diameter of the opening at the back end of the forward part under a no-pressure condition.

6. The nozzle structure of claim 1, wherein the entire nozzle member is made from a flexible, resilient material.
